(19) United States
(12) Patent Application Publication
(10) Pub. No.: US 2010/0220276 A1
(43) Pub. Date: Sep. 2, 2010

(54) LIQUID CRYSTAL DISPLAY DEVICE AND MANUFACTURING METHOD THEREOF

(75) Inventors: Takao SATO, Mobara (JP); Hitoshi Komeno, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/714,744

(22) Filed: Mar. 1, 2010

(30) Foreign Application Priority Data
Mar. 2, 2009 (JP) 2009-047623

(51) Int. Cl. G02F 1/1337; G02F 1/13

(52) U.S. Cl. 349/126; 349/187

(57) ABSTRACT

A liquid crystal display device produced by rubbing a resin film formed on an upper surface of a stacked body in each of panel regions of a first substrate in a direction substantially parallel to or in a direction substantially perpendicular to an arrangement direction of the panel regions, and forming, in the case where a side positioned on a rubbing start side, among sides of each of first organic insulating films, is defined as a first side, and each of sides parallel to a rubbing direction, among sides of a second organic insulating films disposed adjacent to the first side, is defined as a second side, a portion of the first side that crosses the second side when the second side is virtually extended in the rubbing direction so as to have a predetermined angle other than 0° and 90° with respect to a direction perpendicular to the rubbing direction, as viewed in a plane.

### CROSS-REFERENCE TO RELATED APPLICATION

The present application claims priority from Japanese application JP 2009-047623 filed on Mar. 2, 2009, the content of which is hereby incorporated by reference into this application.

### BACKGROUND OF THE INVENTION

1. Field of the Invention

The present invention relates to a method for manufacturing a liquid crystal display device and more particularly to a method for manufacturing a liquid crystal display device in which a plurality of liquid crystal cells are formed by cutting a pair of multi-piece substrates bonded to each other.

2. Description of the Related Art

In the method for manufacturing the liquid crystal display device, a pair of multi-piece substrates on which an image display portion is formed in each of a plurality of regions (panel substrate regions) are bonded together with a sealing material formed so as to surround each of the image display portions with their faces having the image display portions formed thereon facing each other. Thereafter, the pair of multi-piece substrates are cut at locations close to the sealing materials, thereby providing a plurality of liquid crystal cells.

In the method for manufacturing the liquid crystal display device, rubbing is collectively performed on alignment films in the panel substrate regions of the multi-piece substrate.

Examples of the related art of the invention include JP-A-2005-84224, JP-A-2000-29042, and JP-A-2002-350857.

JP-A-2005-84224 describes that protrusions or grooves are disposed along the periphery of the panel substrate region outside the panel substrate region of a substrate. The protrusions or grooves are disposed on an entrance side and an exit side of a rubbing direction of an alignment film, so that dust or the like generated upon a rubbing treatment is removed or blocked.

JP-A-2000-29042 discloses that the line of column spacers is disposed at the periphery of a region that is removed by scribing on a counter substrate or an array substrate for preventing the occurrence of distortion when the array substrate and the counter substrate are bonded together to assemble a cell.

JP-A-2002-350857 discloses that a plurality of convex step portions arranged at an equal distance are disposed outside the panel substrate region of a substrate, and that the pile of a rubbing cloth is allowed to pass through between the convex step portions in a rubbing treatment of an alignment film to correct the deviation of the pile for an aligning treatment. In addition, JP-A-2002-350857 describes that the convex step portions are spacers arranged at the outer periphery of the display region, and that column spacers are disposed in a region surrounded by the convex step portions.

### SUMMARY OF THE INVENTION

In the manufacture of the liquid crystal display device, a plurality of patterned metal films are formed in parallel in some cases in a region (non-panel region) at the periphery of each of the panel substrate regions of one multi-piece substrate (first multi-piece substrate) of the pair of multi-piece substrates. These metal films function as, for example, a mark such as an alignment mark, or a code for specifying each of the panel substrate regions (or liquid crystal cells).

In addition, along with an increase in size of the liquid crystal display device in recent years, column spacers are formed in each of the panel substrate regions of the other multi-piece substrate (second multi-piece substrate) of the pair of multi-piece substrates, and the column spacers are also formed in the non-panel region in some cases. This is because the reliability of gap determination can be ensured over the entire region of the pair of multi-piece substrates.

When a protective film formed of an organic insulating film having a relatively great thickness is formed in each of the panel substrate regions of the first multi-piece substrate, it has been studied that an organic insulating film is formed also in a region of the non-panel region facing the column spacer at the same time of forming the protective film. The organic insulating film is formed as the base of the column spacer, whereby the gap between the substrates is made uniform in the non-panel region and the panel substrate region.

FIG. 14A is a plan view showing a face of the first multi-piece substrate (indicated by reference sign LSB1 in the drawing) of an example for comparison with the invention on a side where an image display portion is formed. FIGS. 14B and 14C are cross-sectional views respectively taken along lines b-b and c-c in FIG. 14A. In FIGS. 14B and 14C, a second multi-piece substrate LSB2 that will be bonded to the first multi-piece substrate in a later step and column spacers PSP formed on the second multi-piece substrate LSB2 are indicated by dotted lines. FIGS. 14A, 14B, and 14C are illustrated respectively corresponding to FIGS. 1A, 1B, and 1C that explain Embodiment 1 of the invention. Therefore, please refer to the description in Embodiment 1 for detailed description other than that described below.

In FIG. 14A, there is the first multi-piece substrate LSB1. In the first multi-piece substrate LSB1, regions for liquid crystal display panels (hereinafter referred to as panel substrate regions PSD) that will be cut later are indicated by dotted-line frames. The panel substrate region PSD has a rectangular shape. For example, two panel substrate regions PSD in the x direction in the drawing and two panel substrate regions PSD in the y direction in the drawing are disposed so as to be separated from one another.

On the surface of each of the panel substrate regions PSD, an image display portion AR having a number of pixels arranged in a matrix is formed. The image display portion AR is formed by stacking a patterned conductive layer, insulating layers, a semiconductor layer, and the like in a predetermined order. In this case, as one of the insulating films, for example, a protective film PAS2 formed of an organic insulating film that is formed by applying a resin and has a relatively great thickness is formed. Further, a resin film RSM (ORI) is formed in the upper most layer of the image display portion AR in contact with liquid crystal. The resin film RSM (ORI) is made to serve as an alignment film ORI by a rubbing treatment described later and is formed in a rectangular pattern having sides close to and substantially parallel to respective sides of the panel substrate region PSD.

In a non-panel region NPD serving as a peripheral region of each of the panel substrate regions PSD, a plurality of patterned metal films MT are formed in parallel along the sides of the panel substrate region PSD. These metal films MT function as, for example, a mark such as an alignment mark, or a code for specifying each of the panel substrate regions (or liquid crystal cells).

In the non-panel region NPD, the metal films MT and organic insulating films OPS are formed in a mixed manner along the sides of the panel substrate region PSD. The organic insulating film OPS is formed in the image display portion AR at the same time of forming the protective film PAS2 and has substantially the same thickness as that of the protective film PAS2. The organic insulating films OPS function as bases of column spacers PSP formed on the second multi-piece substrate LSB2 that is disposed so as to face the first multi-piece substrate LSB1. As indicated by dotted-line circles in FIG. 14A, the column spacers PSP are formed in the panel substrate regions PSD and the non-panel region NPD for ensuring the reliability of gap determination over the entire region of the pair of multi-piece substrates LSB1 and LSB2 that are bonded together. In view of this, the organic insulating films OPS formed in the non-panel region NPD are formed in portions where they face the column spacers PSP (refer to FIGS. 14B and 14C). In this case, the organic insulating film OPS is formed so as to avoid the forming region of the metal film MT. Therefore, the metal film MT functioning as, for example, an alignment mark can be easily seen.

The first multi-piece substrate LSB1 and the second multi-piece substrate LSB2 are bonded together with sealing materials SL shown in FIG. 14C. The sealing material SL is formed at the periphery of each of the panel substrate regions PSD so as to surround the image display portion AR.

In the first multi-piece substrate LSB1, when the alignment film ORI is formed by rubbing the surface of the resin film RSM (ORI) formed in the panel substrate region PSD, a rubbing roller RBL that is disposed, for example, with the axis of rotation coincident with the y direction in the drawing is relatively moved in the x direction in the drawing as shown in FIG. 15A. Specifically, the first multi-piece substrate LSB1 is moved in a direction opposite to the x direction. FIG. 15A shows that the resin films RSM (ORI) serving as the alignment films ORI after a rubbing treatment are formed in the panel substrate regions PSD.

In this case, in each of the panel substrate regions PSD, the organic insulating films OPS formed in the non-panel region NPD on a rubbing start side has substantially a rectangular shape and are formed discontinuously in the axis direction (the y direction in the drawing) of the rubbing roller RBL. As shown in FIG. 15B that is a cross-sectional view taken along line b-b of FIG. 15A, since the organic insulating film OPS has a relatively great thickness (for example, 1 μm or more), a relatively large step portion (indicated by SD in the drawing) is generated between the organic insulating film OPS and the forming region of the metal film MT adjacent thereto.

Therefore, when the rubbing roller RBL runs on the organic insulating films OPS to relatively move in the x direction in the drawing, the step portions SD of the organic insulating films OPS cause fiber irregularities on the rubbing roller RBL. The fiber irregularities cause rubbing lines (linear rubbing non-uniformity) that continue in the x direction in the drawing on the resin film RSM (ORI) on the panel substrate region PSD. That is, the state of the rubbing is different between a portion of the rubbing roller RBL that passes through the organic insulating film OPS and a portion that does not pass through the organic insulating film OPS.

It is an object of the invention to provide a method for manufacturing a liquid crystal display device by which a reliable alignment film with reduced rubbing lines can be provided.

The method for manufacturing the liquid crystal display device of the invention reduces the fiber irregularities of the rubbing roller RBL generated by the step portion of the organic insulating film OPS by devising the planar shape of the organic insulating film OPS or by devising the shape of a side of the protective film PAS2 on a rubbing start side.

For example, the invention can be configured as follows.

(1) The invention is directed to a method for manufacturing a liquid crystal display device including a first multi-piece substrate and a second multi-piece substrate facing the first multi-piece substrate and having a plurality of column spacers formed thereon, the method comprising the steps of: in the first multi-piece substrate, forming a stacked body including a first organic insulating film and a resin film disposed on an upper surface of the stacked body and disposed in a forming region of the first organic insulating film as viewed in a plane in a plurality of rectangular panel substrate regions arranged in the first multi-piece substrate, and forming a plurality of patterned metal films and a plurality of rectangular second organic insulating films disposed so as to avoid forming regions of the metal films and serving as bases of the column spacers in a mixed manner along sides of the panel substrate region in a non-panel region at the periphery of each of the panel substrate regions; and forming an alignment film by rubbing the resin film formed on the upper surface of the stacked body in each of the panel substrate regions of the first multi-piece substrate in a direction substantially parallel to or in a direction substantially perpendicular to an arrangement direction of the panel substrate regions, wherein in the case where, as viewed in a plane, a side positioned on a start side of the rubbing, among sides of each of the first organic insulating films, is defined as a first side, and each of sides substantially parallel to the rubbing direction, among sides of the second organic insulating film disposed adjacent to the first side, is defined as a second side, a portion of the first side that crosses the second side when the second side is virtually extended in the rubbing direction is formed so as to have a predetermined angle other than 0° and 90° with respect to a direction perpendicular to the rubbing direction.

(2) The invention is directed to the method for manufacturing the liquid crystal display device according to (1), wherein the first side of the first organic insulating film has a zigzag shape in which peaks and valleys are repeated along a direction crossing the rubbing direction, as viewed in a plane.

(3) The invention is directed to the method for manufacturing the liquid crystal display device according to (1), wherein the metal film is formed as a mark.

(4) The invention is directed to the method for manufacturing the liquid crystal display device according to (3), wherein the mark is formed as an alignment mark.

(5) The invention is directed to the method for manufacturing the liquid crystal display device according to (1), wherein the metal film is formed as a code.

(6) The invention is directed to a method for manufacturing a liquid crystal display device including a first multi-piece substrate and a second multi-piece substrate facing the first multi-piece substrate and having a plurality of column spacers formed thereon, the method comprising the steps of: in the first multi-piece substrate, forming a stacked body including a first organic insulating film in a plurality of rectangular panel substrate regions arranged in the first multi-piece substrate, and forming a plurality of patterned metal films and a plurality of second organic insulating films disposed so as to avoid forming regions of the metal films and serving as bases of the column spacers in a mixed manner along sides of the panel substrate region in a non-panel region at the periphery of each of the panel substrate regions; and forming an alignment film by rubbing a resin film formed on an upper surface of the stacked body in each of the panel substrate regions of the first multi-piece substrate in a direction substantially parallel to or in a direction substantially perpendicular to an arrangement direction of the panel substrate regions, wherein as viewed in a plane, each of sides crossing a parallel-arranged direction of the second organic insulating films in the second organic insulating film formed in the non-panel region on one side positioned on a start side of the rubbing, among sides of each of the panel substrate regions, has a predetermined angle other than 0° with respect to the rubbing direction.

(7) The invention is directed to the method for manufacturing the liquid crystal display device according to (6), wherein the second organic insulating film formed in the non-panel region on said one side of the panel substrate region is formed in a trapezoidal pattern with the start side of the rubbing being as an upper side and aside facing the upper side being as a base side, as viewed in a plane.

(8) The invention is directed to the method for manufacturing the liquid crystal display device according to (6), wherein the metal film is formed as a mark.

(9) The invention is directed to the method for manufacturing the liquid crystal display device according to (8), wherein the mark is formed as an alignment mark.

(10) The invention is directed to the method for manufacturing the liquid crystal display device according to (6), wherein the metal film is formed as a code.

(11) The invention is directed to a method for manufacturing a liquid crystal display device including a first multi-piece substrate and a second multi-piece substrate facing the first multi-piece substrate and having a plurality of column spacers formed thereon, the method comprising the steps of: in the first multi-piece substrate, forming a stacked body including a first organic insulating film in a plurality of rectangular panel substrate regions arranged in the first multi-piece substrate, and forming a plurality of patterned metal films and a plurality of second organic insulating films disposed so as to avoid forming regions of the metal films and serving as bases of the column spacers in a mixed manner along sides of the panel substrate region in a non-panel region at the periphery of each of the panel substrate regions; and forming an alignment film by rubbing a resin film formed on an upper surface of the stacked body in each of the panel substrate regions of the first multi-piece substrate in a direction substantially parallel to or in a direction substantially perpendicular to an arrangement direction of the panel substrate regions, wherein a hole or a notch is formed in each of the second organic insulating films formed in the non-panel region on one side positioned on a start side of the rubbing, among sides of each of the panel substrate regions, as viewed in a plane, and the second organic insulating film includes a portion where an organic insulating film is formed and a portion where the organic insulating film is not formed along the rubbing direction due to the hole or the notch.

(12) The invention is directed to the method for manufacturing the liquid crystal display device according to (11), wherein the second organic insulating films formed in the non-panel region on said one side of each of the panel substrate regions are each configured by forming the hole and the notch in plural numbers in a staggered form, as viewed in a plane.

(13) The invention is directed to the method for manufacturing the liquid crystal display device according to (11), wherein the second organic insulating films formed in the non-panel region on said one side of each of the panel substrate regions are each configured by disposing a plurality of organic insulating films in a staggered form, as viewed in a plane.

(14) The invention is directed to the method for manufacturing the liquid crystal display device according to (11), wherein the metal film is formed as a mark.

(15) The invention is directed to the method for manufacturing the liquid crystal display device according to (14), the mark is formed as an alignment mark.

(16) The invention is directed to the method for manufacturing the liquid crystal display device according to (11), wherein the metal film is formed as a code.

(17) The invention is directed to the method for manufacturing the liquid crystal display device according to (11), wherein boundaries of fiber irregularities of a rubbing roller for performing the rubbing are made indistinct due to the hole or the notch.

(18) The invention is directed to a liquid crystal display device produced by rubbing a resin film formed on an upper surface of a stacked body in each of panel regions of a first substrate in a direction substantially parallel to or in a direction substantially perpendicular to an arrangement direction of the panel regions, and forming, in the case where a side positioned on a rubbing start side, among sides of each of first organic insulating films, is defined as a first side, and each of sides parallel to a rubbing direction, among sides of a second organic insulating film disposed adjacent to the first side, is defined as a second side, a portion of the first side that crosses the second side when the second side is virtually extended in the rubbing direction so as to have a predetermined angle other than 0° and 90° with respect to a direction perpendicular to the rubbing direction, as viewed in a plane.

The above-described configurations are illustrative only. The invention can be modified properly within a range not departing from the technical idea thereof. Examples of the configurations of the invention other than the above-described configurations will be apparent from the entire description of the specification or the accompanying drawings.

According to the above-described method for manufacturing the liquid crystal display device, a reliable alignment film with reduced rubbing lines can be provided.

Other advantages of the invention will be apparent from the entire description of the specification.

### BRIEF DESCRIPTION OF THE DRAWINGS

FIG. 1A is a schematic configuration view showing a liquid crystal display device and a method for manufacturing the same according to Embodiment 1 of the invention.

FIG. 1B is a schematic configuration view showing the liquid crystal display device and the method for manufacturing the same according to Embodiment 1 of the invention.

FIG. 1C is a schematic configuration view showing the liquid crystal display device and the method for manufacturing the same according to Embodiment 1 of the invention.

FIG. 2 is an equivalent circuit diagram showing an example of an image display portion shown in FIG. 1.

FIG. 3 is a plan view showing a sealing material formed in a panel substrate region shown in FIG. 1.

FIG. 4 is a schematic plan view showing a rubbing step in the method for manufacturing the liquid crystal display device according to the invention.

FIG. 5 is an enlarged view showing a detailed configuration of a protective film shown in FIG. 1.

FIG. 6 is an enlarged view showing another detailed configuration of the protective film shown in FIG. 1.

FIG. 7A is a configuration view showing an example of the configuration of a pixel shown in FIG. 1.

FIG. 7B is a configuration view showing the example of the configuration of the pixel shown in FIG. 1.

FIG. 8 is a schematic configuration view showing a liquid crystal display device and a method for manufacturing the same according to Embodiment 2 of the invention.

FIG. 9A is a schematic configuration view showing a liquid crystal display device and a method for manufacturing the same according to Embodiment 3 of the invention.

FIG. 9B is a schematic configuration view showing the liquid crystal display device and the method for manufacturing the same according to Embodiment 3 of the invention.

FIG. 10 is a schematic configuration view showing another configuration of a portion shown in FIG. 9B.

FIG. 11 is an explanatory view showing a minimum range of a portion in FIG. 9A to which the invention is applied.

FIG. 12A is a schematic configuration view showing a liquid crystal display device and a method for manufacturing the same according to Embodiment 4 of the invention.

FIG. 12B is a schematic configuration view showing the liquid crystal display device and the method for manufacturing the same according to Embodiment 4 of the invention.

FIG. 13 is a schematic configuration view showing another configuration of a portion shown in FIG. 12B.

FIG. 14A is a schematic configuration view showing an example of a liquid crystal display device and a method for manufacturing the same according to a comparative example.

FIG. 14B is a schematic configuration view showing the example of the liquid crystal display device and the method for manufacturing the same according to the comparative example.

FIG. 14C is a schematic configuration view showing the example of the liquid crystal display device and the method for manufacturing the same according to the comparative example.

FIG. 15A is an explanatory view showing a disadvantage of a liquid crystal display device and a method for manufacturing the same according to the comparative example.

FIG. 15B is an explanatory view showing the disadvantage of the liquid crystal display device and the method for manufacturing the same according to the comparative example.

### DESCRIPTION OF THE PREFERRED EMBODIMENTS

Embodiments of the invention will be described with reference to the drawings. In the drawings and embodiments, the same or similar constituent elements are denoted by the same reference numerals, and the description thereof is omitted.

### Embodiment 1

### (Overall Configuration)

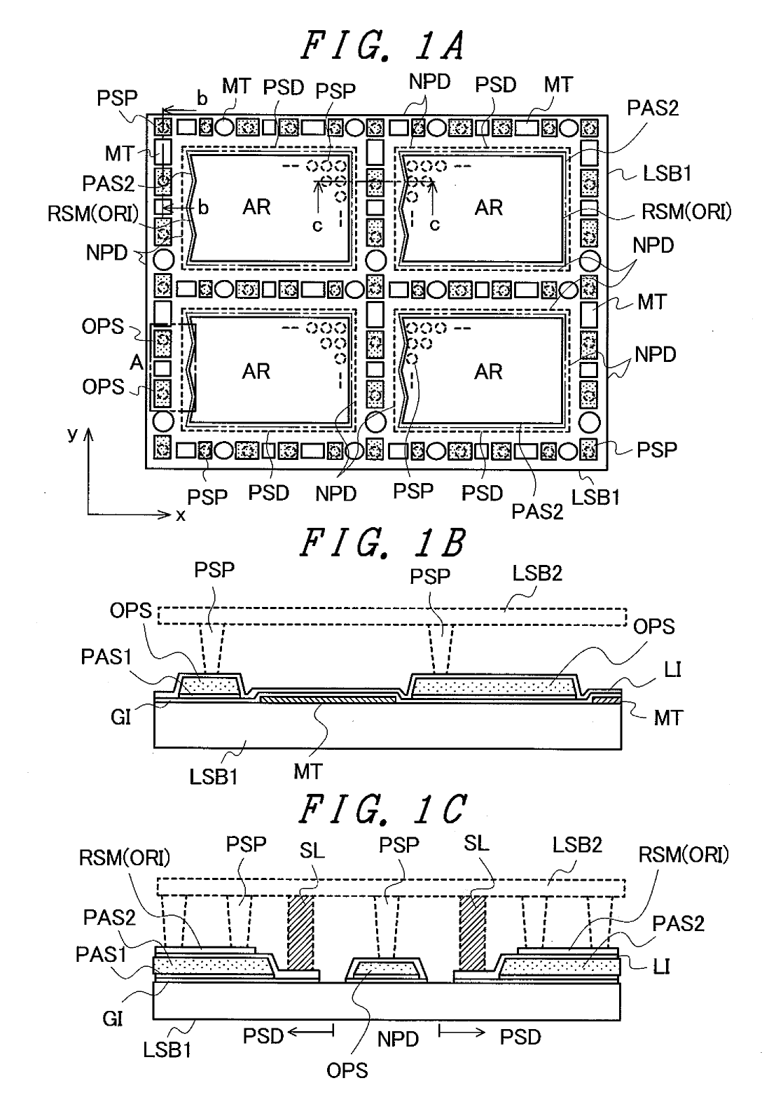

FIG. 1A is a configuration view of a main part of a method for manufacturing a liquid crystal display device according to Embodiment 1 of the invention, which is a plan view showing a multi-piece substrate LSB1 (hereinafter referred to as a first multi-piece substrate LSB1) as one of a pair of multi-piece substrates arranged to face each other with liquid crystal interposed therebetween. FIGS. 1B and 1C show cross-sectional views respectively taken along lines b-b and c-c of FIG. 1A. In FIGS. 1B and 1C, a second multi-piece substrate LSB2 that will be bonded to the first multi-piece substrate in a later step and column spacers PSP formed on the second multi-piece substrate LSB2 are indicated by dotted lines. FIGS. 1B and 1C illustrate them in this way for clearly showing the positions of the column spacers PSP above the first multi-piece substrate LSB1.

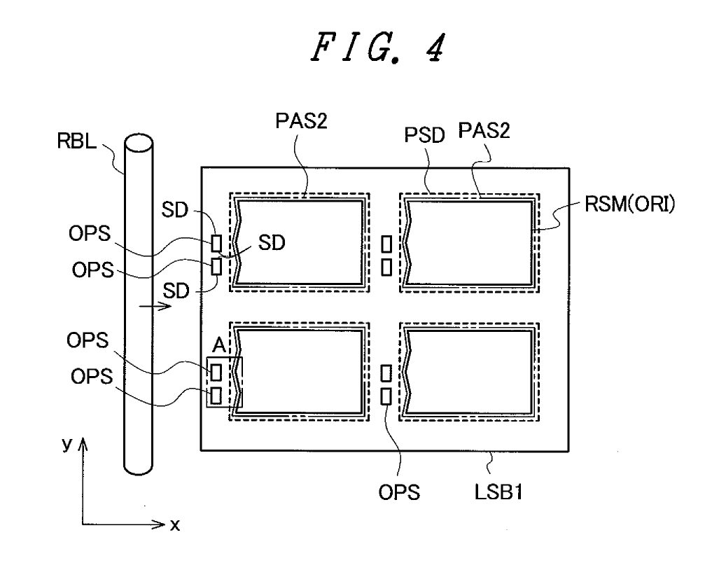

FIG. 1A shows a plan view of the first multi-piece substrate LSB1 immediately before an alignment film ORI is formed by rubbing a resin film RSM (ORI) formed in the uppermost layer of the main face of the first multi-piece substrate by using a rubbing roller (indicated by reference sign RBL in FIG. 4). After the rubbing is performed, the first multi-piece substrate LSB1 is bonded to the second multi-piece substrate LSB2 with sealing materials SL (refer to FIG. 1C). After the gap is determined, the first multi-piece substrate LSB1 is cut together with the second multi-piece substrate LSB2 and separated into each liquid crystal display panel.

In the first multi-piece substrate LSB1 shown in FIG. 1A, regions for liquid crystal display panels (hereinafter referred to as panel substrate regions PSD) that will be cut later are indicated by dotted-line frames. In FIG. 1A, for example, four rectangular panel substrate regions PSD, that is, two panel substrate regions in the x direction in the drawing and two panel substrate regions in the y direction in the drawing, are arranged in one first multi-piece substrate LSB1 while being separated from one another. However, the number of the panel substrate regions PSD and the arrangement thereof are not necessarily limited to those described above.

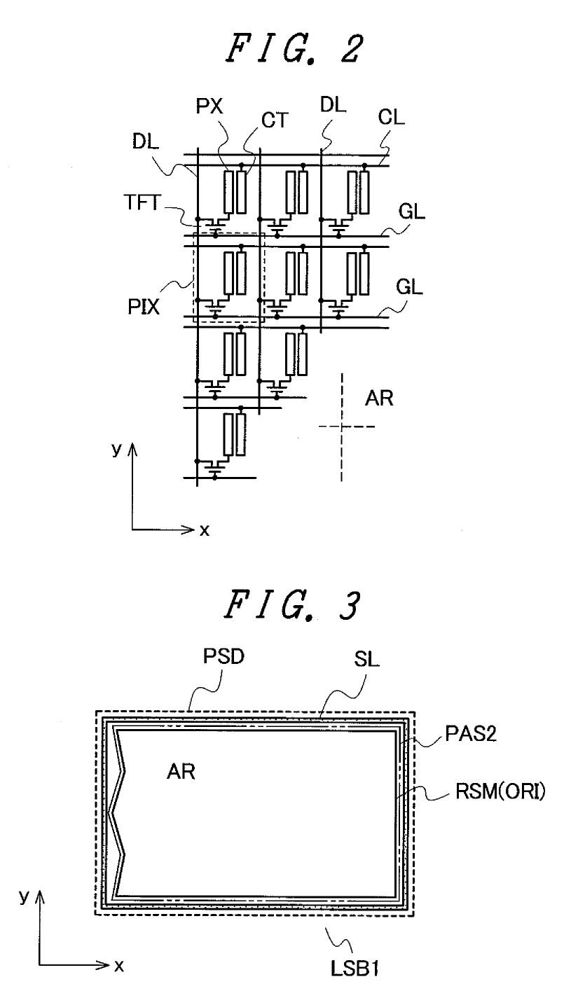

An image display portion AR is formed on the surface of the panel substrate region PSD. The image display portion AR is composed of a number of pixels arranged in a matrix. FIG. 2 shows an equivalent circuit of the image display portion AR. As shown in FIG. 2, a rectangular region surrounded by gate signal lines GL extended in the x direction in the drawing and arranged in parallel in the y direction in the drawing and drain signal lines DL extended in the y direction in the drawing and arranged in parallel in the x direction in the drawing is defined as a pixel region (indicated by a dotted-line frame PIX in the drawing). In the pixel region, a thin film transistor TFT, a pixel electrode PX, and a counter electrode CT are provided. The thin film transistor TFT is turned on with the supply of a scanning signal from one of the gate signal lines GL. The pixel electrode PX is supplied with a video signal from one of the drain signal lines DL through the turned-on thin film transistor TFT. The counter electrode CT generates an electric filed in liquid crystal between the counter electrode and the pixel electrode PX. The counter electrode CT is supplied with a reference signal for the video signal through a common signal line CL. Such a pixel has a configuration referred to as of an IPS (In Plane Switching) type or a lateral electric field type. However, the invention is not limited to the configuration but can be applied to a configuration referred to as of a TN (Twisted Nematic) or STN (Super Twisted Nematic) type, or a vertical electric filed type.

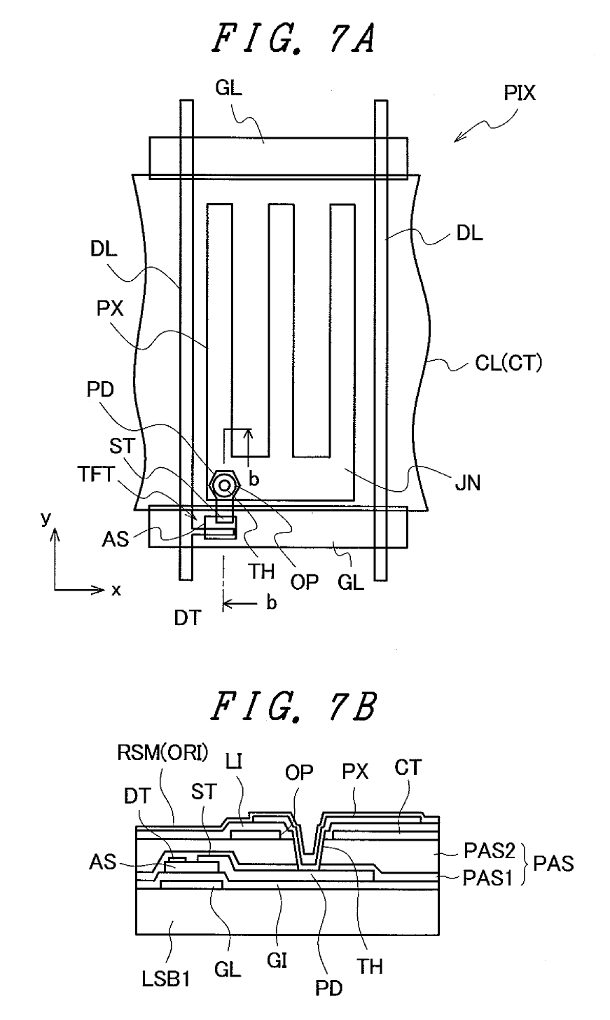

Such a pixel is formed of a stacked body including a patterned conductive film, insulating films, and a semiconductor film stacked in a predetermined order in the panel substrate region PSD. In this case, as one of the insulating films, a protective film PAS2 (indicated by a two-dot chain line in FIG. 1A) that is formed so as to cover the thin film transistor TFT is provided. The protective film PAS2 is formed of an organic insulating film (referred to as a first organic insulating film in some cases) having a great thickness (for example, 1 μm or more) and made of, for example, a resin. The resin film RSM (ORI) is formed on the upper surface of the stacked body. The resin film RSM (ORI) is formed in the forming region of the protective film PAS2 as viewed in a plane. A rubbing treatment described later is applied to the resin film RSM (ORI), whereby the resin film RSM (ORI) serves as the alignment film ORI. The alignment film ORI serves as a film in contact with liquid crystal and determines an initial alignment direction of liquid crystal molecules. As viewed in a plane, a side positioned on a rubbing start side (for example, a side on the left in the drawing between the sides extending in the y direction in the drawing), among the sides of the protective film PAS2, has a zigzag shape in which peaks and valleys are repeated along a direction (in the y direction in the drawing) crossing a direction of the rubbing (in the x direction in the drawing). The protective film PAS2 is formed in the shape for decreasing rubbing lines generated on the resin film RSM (ORI) when the resin film RSM (ORI) is rubbed. The reason will be described in detail later. FIG. 1A shows the pitch of the zigzag formed for the side of the protective film PAS2 in an enlarged scale for clearly showing the shape. The resin film RSM (ORI) formed on the uppermost layer side of the protective film PAS2 has a smaller area than that of the protective film PAS2 and has a shape substantially similar to that of the protective film PAS2. The detailed configuration of the pixel will be described later with reference to FIG. 7.

As shown in FIG. 3, the sealing material SL is formed so as to surround the image display portion AR in each of the panel substrate regions PSD at the periphery thereof. The sealing material SL is formed before bonding the first multi-piece substrate LSB1 to the second multi-piece substrate LSB2 (after the formation of the alignment film ORI). While the sealing material SL shown in FIG. 3 is not provided with a liquid crystal sealing port but may be provided with the same. The invention is applicable irrespective of difference in method for filling liquid crystal into a liquid crystal cell.

Returning to FIG. 1A, a non-panel region NPD as a region other than the panel substrate region PSD described above is provided on the main face of the first multi-piece substrate LSB1. The non-panel region NPD is formed in the peripheral region of each of the panel substrate regions PSD. That is, the non-panel region NPD includes a region between the circumferential outline of the first multi-piece substrate LSB1 and the panel substrate regions PSD and regions between the panel substrate regions PSD adjacent to one another.

Patterned metal films MT are formed in the non-panel region NPD. The metal films MT are formed along the sides of each of the panel substrate regions PSD and function as, for example, a mark such as an alignment mark, or a code for specifying each of the panel substrate regions PSD (or liquid crystal cells). The metal film MT is formed of the material of the gate signal line GL at the same time of forming the gate signal line GL when the gate signal line GL is formed in the panel substrate region PSD, for example. However, this is not restrictive. The metal film MT may be formed of the material of the drain signal line DL at the same time of forming the drain signal line DL. In addition, the metal film MT may be formed in combination of one formed of the material of the gate signal line GL at the same time of forming the gate signal line GL and one formed of the material of the drain signal line DL at the same time of forming the drain signal line DL.

Organic insulating films OPS are formed in the non-panel region NPD. The organic insulating films OPS function as bases of column spacers PSP formed in regions of the second multi-piece substrate LSB2 facing the non-panel region NPD when the second multi-piece substrate LSB2 is bonded to the first multi-piece substrate LSB1.

The column spacers PSP are dispersedly formed on the second multi-piece substrate LSB2 both in a region facing the panel substrate region PSD and in a region facing the non-panel region NPD (these column spacers PSP are indicated by dotted-line circles in FIG. 1A). As described above, the column spacers PSP are formed also in the non-panel region NPD for ensuring the reliability of gap determination over the entire region of the pair of multi-piece substrates LSB1 and LSB2 bonded together.

The organic insulating films OPS are formed at the same time of forming the protective film (organic insulating film) PAS2 in the image display portion AR and has substantially the same thickness as that of the protective film PAS2. The organic insulating films (referred to as second organic insulating films in some cases) OPS are formed along the sides of each of the panel substrate regions PSD. The organic insulating film OPS is formed in a rectangular shape having sides substantially parallel to the x and y directions in the drawing. The term “substantially parallel” as used herein includes an error of within ±1°, for example.

The organic insulating films OPS and the metal films MT are formed in a mixed manner along the sides of the panel substrate region PSD. The organic insulating film OPS is formed so as to avoid the forming region of the metal film MT. The metal film MT functioning as a mark such as an alignment mark or a code is formed so as not to be overlapped with the organic insulating film OPS, whereby the metal film can be easily seen.

As shown in FIGS. 1A and 1B, in addition to the metal film MT and the organic insulating film OPS, an insulating film GI, a protective film PAS1, an insulating film LI, and the like, for example, are also formed by stacking in the non-panel region NPD of the first multi-piece substrate LSB1. This is because the height of the face abutting the top of the column spacer PSP in the non-panel region NPD is made substantially the same as that in the panel substrate region PSD.

As shown in FIG. 4, the thus configured first multi-piece substrate LSB1 undergoes the step of forming the alignment films ORI by rubbing the resin films RSM (ORI) formed in the uppermost layer on the face thereof in the panel substrate regions PSD by using the rubbing roller RBL. The first multi-piece substrate LSB1 shown in FIG. 4 has the same configuration as that of the first multi-piece substrate LSB1 shown in FIG. 1A. However, the first multi-piece substrate LSB1 shown in FIG. 4 is illustrated in a simplified manner. The illustration of the metal film MT is omitted in the non-panel region NPD of the first multi-piece substrate LSB1, and only the organic insulating films OPS adjacent to a side of the protective film PAS2 positioned on the rubbing start side is shown among the organic insulating films OPS formed along the sides of each of the panel substrate regions PSD. This is because when the resin film RSM (ORI) is rubbed, the organic insulating films OPS illustrated in FIG. 4 cause rubbing lines on the resin film RSM (ORI).

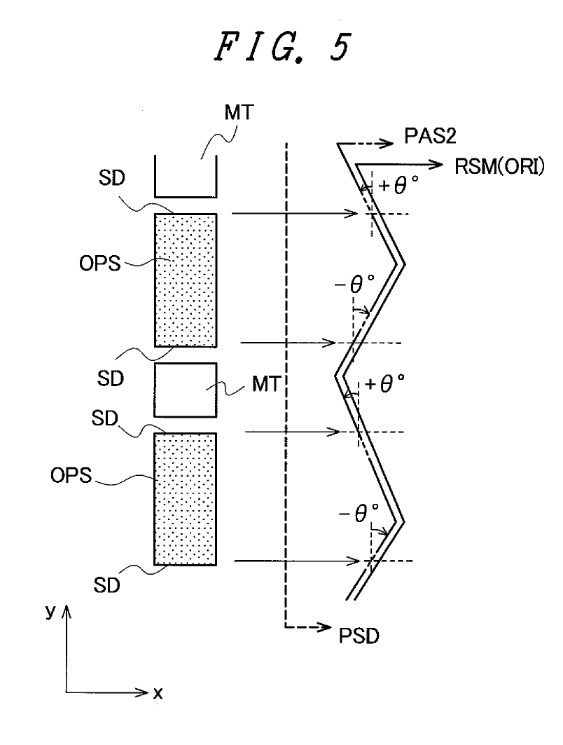

In FIG. 4, for example, the rubbing roller RBL relatively moves in the x direction in the drawing with the axis of rotation coincident with the y direction in the drawing. Actually, the first multi-piece substrate LSB1 moves in a direction opposite to the x direction. That is, rubbing is performed in a direction substantially parallel to or in a direction substantially perpendicular to the arrangement direction of the panel substrate regions PSD. The term “substantially” as used herein includes an error of within ±1°. In this case, the organic insulating film OPS in the drawing on which the rubbing roller RBL runs upon relative movement of the rubbing roller RBL has step portions (indicated by SD in the drawing) in the axis direction (in the y direction in the drawing) of the rubbing roller RBL. Therefore, fiber irregularities occur on part of the rubbing roller RBL in the axis direction due to the step portions SD. Immediately thereafter, however, the rubbing roller RBL runs on step portions due to the protective films PAS2. In this case, as shown in FIG. 5 that is an enlarged view of a dashed-line frame A (the dashed-line frame A is also shown at the same location in FIG. 1A) of FIG. 4, the portion of the rubbing roller RBL where the fiber irregularities occur runs on a side having a predetermined angle (+Θ° or −η°) other than 0° and 90° with respect to a direction (in the y direction in the drawing) perpendicular to a rubbing direction in the protective film PAS2 as viewed in a plane. In this case, since the timing when the rubbing roller RBL reaches the protective film PAS2 varies depending on positions of the rubbing roller RBL in the axis direction, it is confirmed that the fiber irregularities of the rubbing roller RBL are segmented into small ones, and that the boundaries are no more distinct. In the case of a comparative example with no angle described above (Θ°=0°), the fiber irregularities of the rubbing roller RBL are maintained as they are. In the case of Θ°=90°, boundaries of new fiber irregularities are generated. Accordingly, with the above-described configuration, the fiber irregularities are decreased in the rubbing roller RBL that moves later on the resin film RSM (ORI), whereby it is possible to prevent the occurrence of so-called rubbing lines on the alignment film ORI.

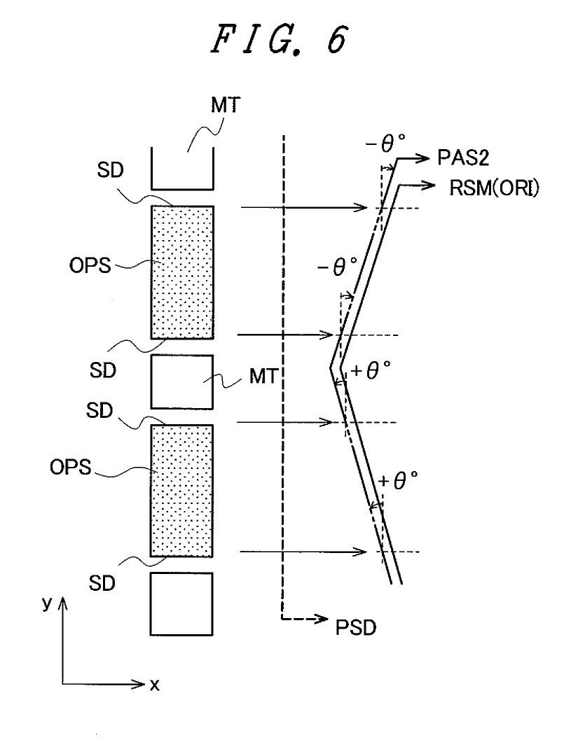

In view of the reasons described above, as viewed in a plane, in the case where a side positioned on the rubbing start side, among the sides of each of the protective films PAS2, is defined as a first side, and each of sides (constituting the step portions SD) (sides substantially parallel to the rubbing direction) crossing a parallel-arranged direction of the organic insulating films OPS, among the sides of the organic insulating film OPS disposed adjacent to the first side, is defined as a second side, if a portion of the first side that crosses the second side when the second side is virtually extended in the rubbing direction has a predetermined angle other than 0° and 90° with respect to a direction perpendicular to the rubbing direction, a reliable rubbing can be applied to the resin film RSM (ORI). The term “substantially parallel” as used herein includes an error of within ±1°, for example. The predetermined angle is preferably 10° or more and 80° or less. Therefore, as long as the condition is satisfied, the positions of peaks or valleys of the zigzag formed for the side of the protective film PAS2 positioned on the rubbing start side may be opposite from those shown in FIG. 5. In addition, as shown in FIG. 6 that is illustrated corresponding to FIG. 5, for example, the pitch of repetitive peaks or valleys may be different. However, it has been confirmed that when the pitch in this case is formed to a size corresponding to one to several pixels with the pixel formed in the image display portion AR being as a reference, the fiber irregularities of the rubbing roller RBL are segmented into small ones, so that non-uniformity is no more distinct visually. By forming the pitch to the size, the dimension of the region for forming the zigzag (dimension in the x direction in the drawing) can be narrowed.

In the above-described embodiment, when the side of the protective film PAS2 is formed in, for example, a zigzag shape, only the side positioned on the rubbing start side is formed in a zigzag shape. However, this is not restrictive. Another side may be formed also in a zigzag shape.

### (Configuration of Pixel)

FIGS. 7A and 7B show the configuration of a pixel formed in the panel substrate region PSD of the first multi-piece substrate LSB1, showing the configuration of the pixel region PIX in FIG. 2. FIG. 7A is a plan view. FIG. 7B is a cross-sectional view taken along line b-b of FIG. 7A.

First, the gate signal lines GL extended in the x direction in the drawing and arranged in parallel in the y direction are formed on the face of the panel substrate region PSD. The insulating film GI is formed on the face of the panel substrate region PSD so as to cover the gate signal lines GL. The insulating film GI functions as a gate insulating film in the forming region of the thin film transistor TFT described later.

A semiconductor layer AS formed of, for example, amorphous Si is formed in an island shape on the surface of the gate insulating film GI in the forming region of the thin film transistor TFT that is partially overlapped with the gate signal line GL. In the thin film transistor TFT, a drain electrode DT and a source electrode ST that are disposed to face each other are formed on the surface of the semiconductor layer AS, whereby a MIS (Metal Insulator Semiconductor) transistor of an inverse staggered structure in which a part of the gate signal line GL forms a gate electrode is configured.

The drain signal lines DL extending in the y direction in the drawing and arranged in parallel in the x direction are formed on the face of the panel substrate region PSD. A part of the drain signal line DL is extended on the surface of the semiconductor layer AS, so that the extended portion serves as the drain electrode DT of the thin film transistor TFT. When the drain signal line DL is formed, the source electrode ST of the thin film transistor TFT is formed. The source electrode ST includes a pad PD extending to a pixel region beyond the forming region of the semiconductor layer AS. The pad PD is configured as a portion to be electrically connected to the pixel electrode PX described later.

A protective film PAS is formed on the face of the panel substrate region PSD so as to cover the drain signal lines DL and the like. The protective film PAS is formed of insulating films for avoiding the direct contact of the thin film transistor TFT and liquid crystal. For example, the protective film PAS has a stacked structure of the protective film PAS1 formed of an inorganic insulating film and the protective film PAS2 formed of an organic insulating film. An organic insulating film is used for the protective film PAS2 for planarizing the surface thereof, for example.

The common signal line CL is formed on the surface of the protective film PAS2 between a pair of gate signal lines GL adjacent to each other along a traveling direction of the gate signal line GL. The common signal line CL is formed so as to cover substantially the entire region of pixel regions arranged in parallel in the x direction in the drawing and functions also as the counter electrode CT in each of the pixel regions. The common signal line CL (the counter electrode CT) is formed of a translucent conductive film made of, for example, ITO (Indium Tin Oxide).

The insulating film LI formed of an inorganic insulating film is formed on the face of the panel substrate region PSD so as to cover the common signal line CL (the counter electrode CT). The pixel electrode PX is formed on the upper surface of the insulating film LI in each of the pixel regions. The insulating film LI functions as an inter-layer insulating film for establishing inter-layer insulation between the pixel electrode PX and the counter electrode CT described later. For example, the pixel electrode PX includes a plurality (for example, three in the drawing) of linear electrodes extended in the y direction in the drawing and arranged in parallel in the x direction. These electrodes include a connection JN where the electrodes are connected to one another at an end on the thin film transistor TFT side. The pixel electrode PX is formed of a translucent conductive film made of, for example, ITO (Indium Tin Oxide). A part of the connection JN of the pixel electrode PX is electrically connected to the pad PD of the source electrode ST through the inter-layer insulating film LI and a through hole TH formed through the protective film PAS. In this case, in the common signal line CL (the counter electrode CT), an opening OP having a sufficiently larger diameter than that of the through hole TH is previously formed substantially concentrically with the through hole TH, whereby electrical short between the pixel electrode PX and the counter electrode CT is avoided.

In the pixel shown in FIGS. 7A and 7B, the resin film RSM (ORI) is formed on the insulating film LI so as to cover the pixel electrode PX. An alignment film is formed by rubbing the resin film RSM (ORI) by using the rubbing roller RBL shown in FIG. 4.

When the pixel having the configuration is formed, the sequential stacked body formed of the metal film MT, the insulating film GI, the protective film PAS1, the organic insulating film OPS (the protective film PAS2), and the insulating film LI is formed in the non-panel region NPD of the first multi-piece substrate LSB1, as shown in FIGS. 1B and 1C. However, the insulating film GI, the protective film PAS1, and the insulating film LI may be not formed partially or entirely in the non-panel region NPD as long as uniformity of the gap between the substrates gives no problem. As described above, in the non-panel region NPD, the metal film MT constitutes a mark such as an alignment mark, or a code for specifying each of the panel substrate regions PSD (or liquid crystal cells), and the organic insulating film OPS constitutes the base of the column spacer PSP.

### Embodiment 2

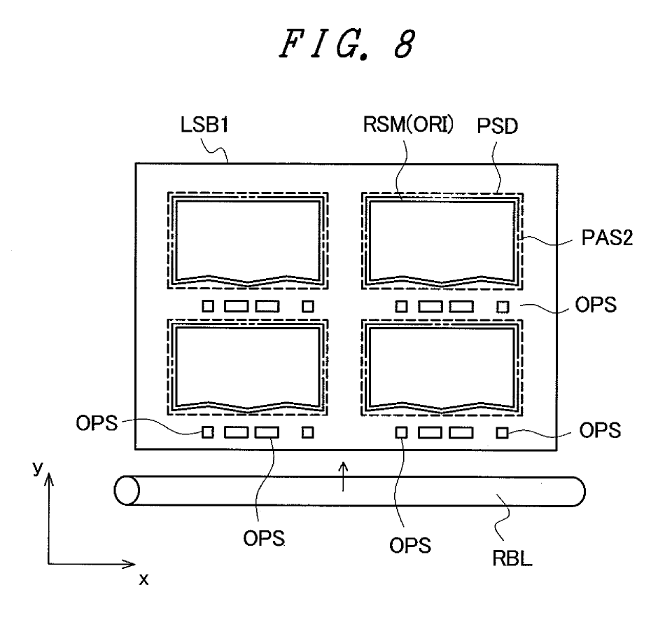

FIG. 8 shows a configuration view of a main part of a method for manufacturing a liquid crystal display device according to Embodiment 2 of the invention, corresponding to FIG. 4.

First, the configuration of FIG. 8 differs from that of FIG. 4 in the rubbing roller RBL. The rubbing roller RBL is disposed with the axis of rotation coincident with the x direction in the drawing and is relatively moved in the y direction in the drawing, whereby rubbing is applied to the resin film RSM (ORI) formed on the first multi-piece substrate LSB1. Actually, the first multi-piece substrate LSB1 moves in a direction opposite to the y direction. That is, rubbing is performed in a direction substantially parallel to or in a direction substantially perpendicular to the arrangement direction of the panel substrate regions PSD. The term “substantially” as used herein includes an error of within ±1°.

The protective film PAS2 formed in the panel substrate region PSD is formed in a zigzag shape at a side positioned on the rubbing start side. In FIG. 8, however, the rubbing start side is the lower side of the first multi-piece substrate LSB1, which is different from Embodiment 1. The other configurations are basically the same as in Embodiment 1.

### Embodiment 3

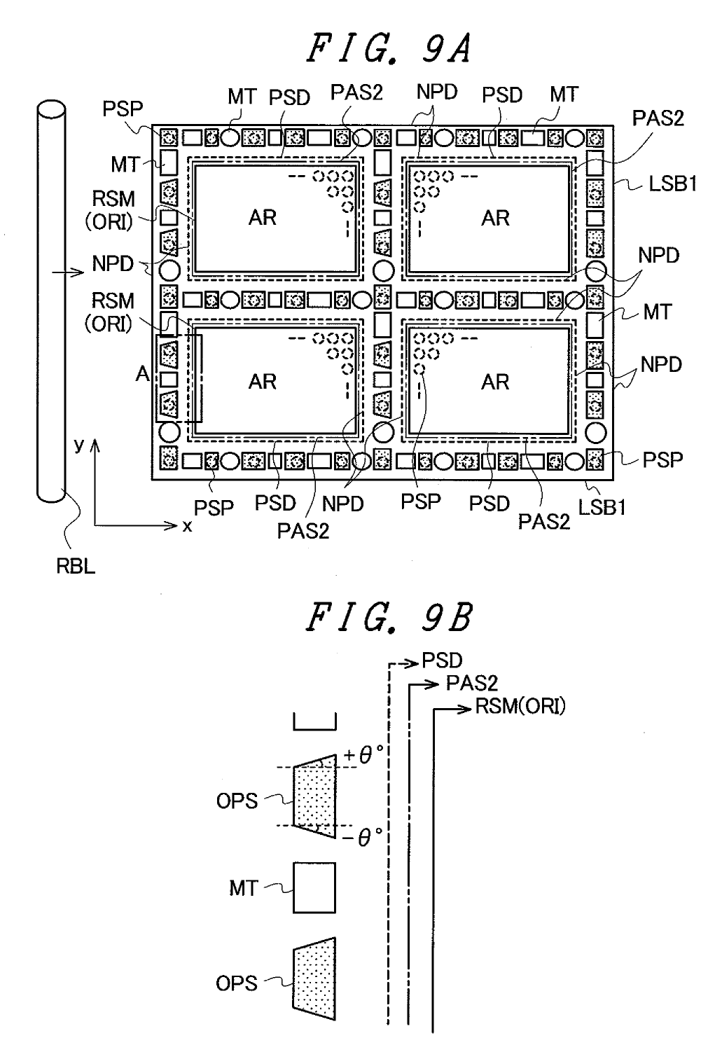

FIG. 9A shows a configuration view of a main part of a method for manufacturing a liquid crystal display device according to Embodiment 3 of the invention, corresponding to FIG. 1A.

In the case of FIG. 9A, the rubbing roller RBL is expected to relatively move in the x direction in the drawing with the axis of rotation coincident with the y direction in the drawing as shown in the drawing.

The configuration of FIG. 9A differs from that of FIG. 1A in the organic insulating films OPS formed in the non-panel region NPD on a side positioned on the rubbing start side, among the sides of each of the panel substrate regions PSD. The organic insulating film OPS is formed in a special shape as viewed in a plane, whereby rubbing lines generated when the resin film RSM (ORI) is rubbed are decreased.

Therefore, the protective film PAS2, as viewed in a plane, is not specially devised at the side but has a typical rectangular shape, which is different from Embodiment 1. In addition, the resin film RSM (ORI) formed in the forming region of the protective film PAS2 has also a rectangular shape similar to the protective film PAS2.

FIG. 9B is an enlarged view of a dashed-line frame A in FIG. 9A, showing the planar shape of the organic insulating films OPS formed in the non-panel region NPD on the side positioned on the rubbing start side, among the sides of each of the panel substrate regions PSD. In FIG. 9B, for example, two organic insulating films OPS are arranged in parallel along the side of the panel substrate region PSD. Both of the organic insulating films OPS are formed in a trapezoidal pattern with the rubbing start side being as an upper side and a side facing the upper side being as a base side. The pattern of the organic insulating film OPS is formed for allowing, in the organic insulating film OPS, each of sides crossing the parallel-arranged direction of the organic insulating films OPS to have a predetermined angle (indicated by +Θ° or −Θ° in the drawing) other than 0° with respect to the rubbing direction. Here, Θ is preferably 10° or more and 80° or less and more preferably, 10° or more and 60° and or less.

In this case, when the rubbing roller RBL is relatively moved to run on the organic insulating film OPS, in the organic insulating film OPS, the fiber irregularities of the rubbing roller RBL generated at the locations of the sides of the organic insulating film OPS crossing the parallel-arranged direction thereof can be dispersed in the axis direction of the rubbing roller RBL. Therefore, the boundary between a portion where the fiber irregularities are generated and a portion where the fiber irregularities are not generated can be made indistinct. Accordingly, with the above-described configuration, the fiber irregularities are decreased in the rubbing roller RBL that moves later on the resin film RSM (ORI) compared with a comparative example, whereby it is possible to decrease the occurrence of so-called rubbing lines on the alignment film ORI.

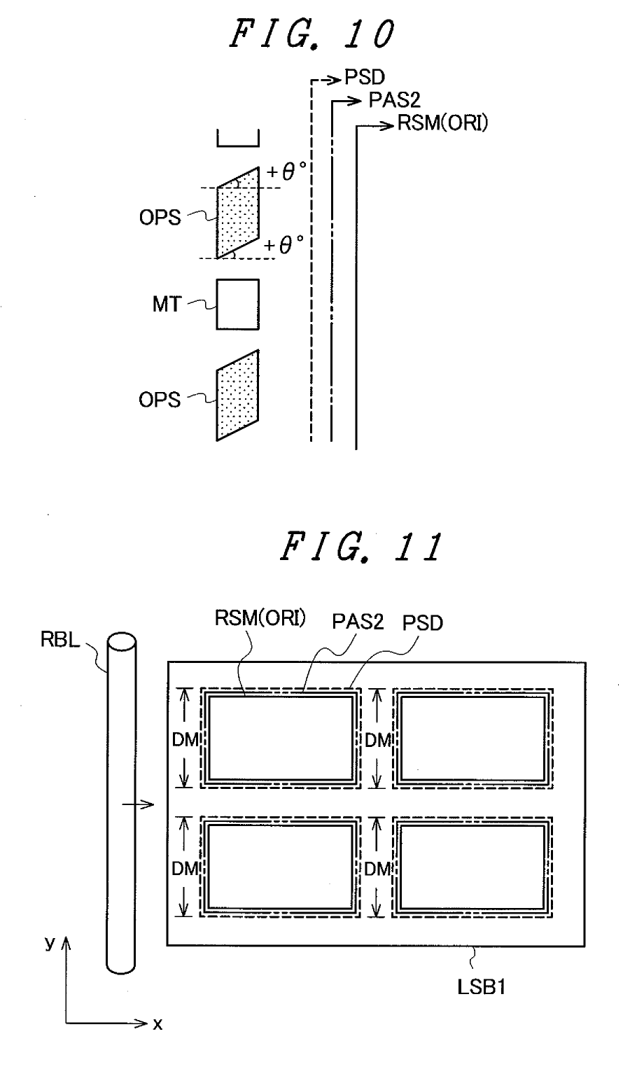

In the case of FIGS. 9A and 9B, the organic insulating film OPS is formed in a trapezoidal shape. However, the shape is not limited to a trapezoidal shape. For example, as shown in FIG. 10 that is illustrated corresponding to FIG. 9B, the same effect can be provided when the organic insulating film OPS is formed in a rhombic shape. Also in this case, each of the sides of the organic insulating film OPS crossing the parallel-arranged direction of the organic insulating films OPS has a predetermined angle (indicated by +Θ° in the drawing) other than 0° with respect to the rubbing direction. Also the thus configured side can decrease the fiber irregularities of the rubbing roller RBL.

As shown in FIG. 11, the organic insulating films OPS having the above-described pattern among the organic insulating films OPS formed at the periphery of the panel substrate region PSD are the organic insulating films OPS in the non-panel region on the side positioned on the rubbing start side, among the sides of each of the panel substrate regions PSD, that is, in a range indicated by DM in the drawing. This is because the portion of the rubbing roller RBL used for rubbing the resin film RSM (ORI) is a portion corresponding to the range indicated by DM in FIG. 11. Therefore, it is sufficient that the organic insulating films OPS formed in this portion are configured as described above. However, this is not restrictive. Another organic insulating film OPS formed at the periphery of the panel substrate region PSD may be formed in the above-described pattern.

Embodiment 3 shows the case where the rubbing roller RBL is relatively moved in the x direction in the drawing with the axis of rotation coincident with the y direction in the drawing. However, this is not restrictive. Embodiment 3 may be applied to the case where the rubbing roller RBL is relatively moved in the y direction in the drawing with the axis of rotation coincident with the x direction in the drawing. In this case, in the organic insulating films OPS formed in the non-panel region on a side positioned on the rubbing start side (lower side in this case), each of the sides crossing the parallel-arranged direction of the organic insulating films OPS is configured so as to have a predetermined angle other than 0° with respect to the rubbing direction.

### Embodiment 4

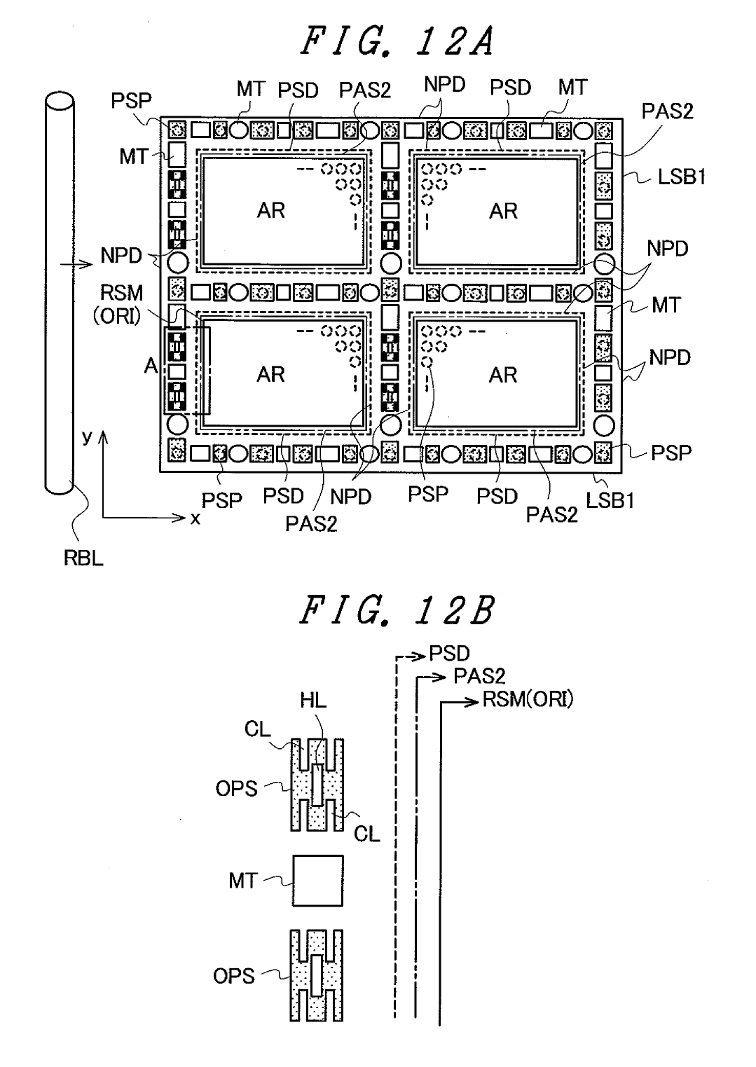

FIG. 12A shows a configuration view of a main part of a method for manufacturing a liquid crystal display device according to Embodiment 4 of the invention, corresponding to FIG. 9A.

Also in the case of FIG. 12A, similarly to FIG. 9A, the shape of the organic insulating films OPS formed in the non-panel region NPD on a side positioned on the rubbing start side, among the sides of each of the panel substrate regions PSD, is devised. As viewed in a plane, the organic insulating film OPS is formed in a special shape, whereby rubbing lines generated when the resin film RSM (URI) is rubbed are decreased.

Therefore, the protective film PAS2, as viewed in a plane, is not specially devised at the side but has a typical rectangular shape, which is different from Embodiment 1. In addition, the resin film RSM (ORI) formed in the forming region of the protective film PAS2 has also a rectangular shape similar to the protective film PAS2.

FIG. 12B is an enlarged view of a dashed-line frame A in FIG. 12A, showing the planar shape of the organic insulating films OPS formed in the non-panel region NPD on the side positioned on the rubbing start side, among the sides of each of the panel substrate regions PSD. In FIG. 12B, for example, two organic insulating films OPS are arranged in parallel along the side of the panel substrate region PSD. Both of the organic insulating films OPS are formed in a pattern in which a plurality of holes HL and notches CL are formed in a staggered form. The pattern of the organic insulating film OPS is formed for providing a portion where an organic insulating film is formed and a portion where the organic insulating film is not formed along the rubbing direction in the organic insulating film OPS.

In this case, when the rubbing roller RBL is relatively moved to run on the organic insulating film OPS, fiber irregularities occur on the rubbing roller RBL at an end side of the organic insulating film OPS on the rubbing roller RBL side. However, when the rubbing roller RBL passes through the organic insulating film OPS, the boundary between a portion where the fiber irregularities have occurred and a portion where the fiber irregularities have not occurred can be made indistinct due to the portion where an organic insulating film is formed and the portion where the organic insulating film is not formed, the portions being arranged with a short distance. Accordingly, with the above-described configuration, the fiber irregularities are decreased in the rubbing roller RBL that moves later on the resin film RSM (ORI) compared with a comparative example, whereby it is possible to decrease the occurrence of so-called rubbing lines on the alignment film ORI.

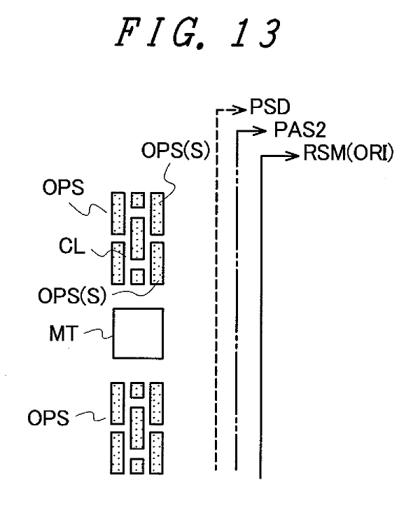

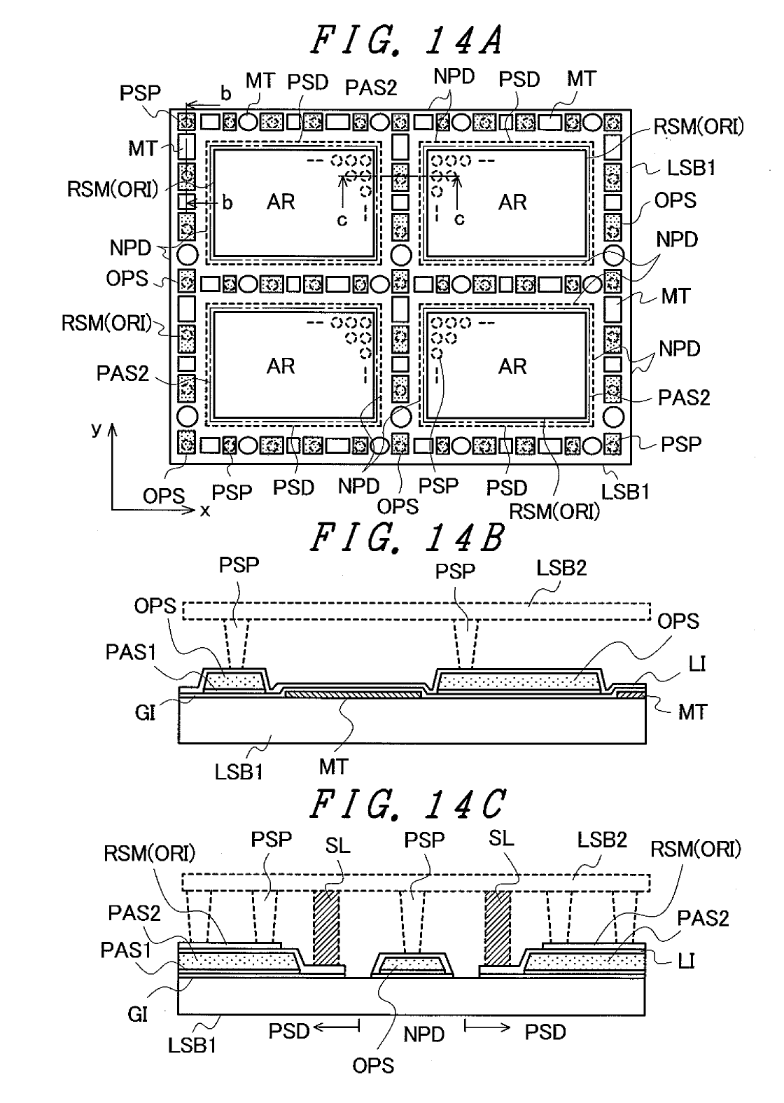

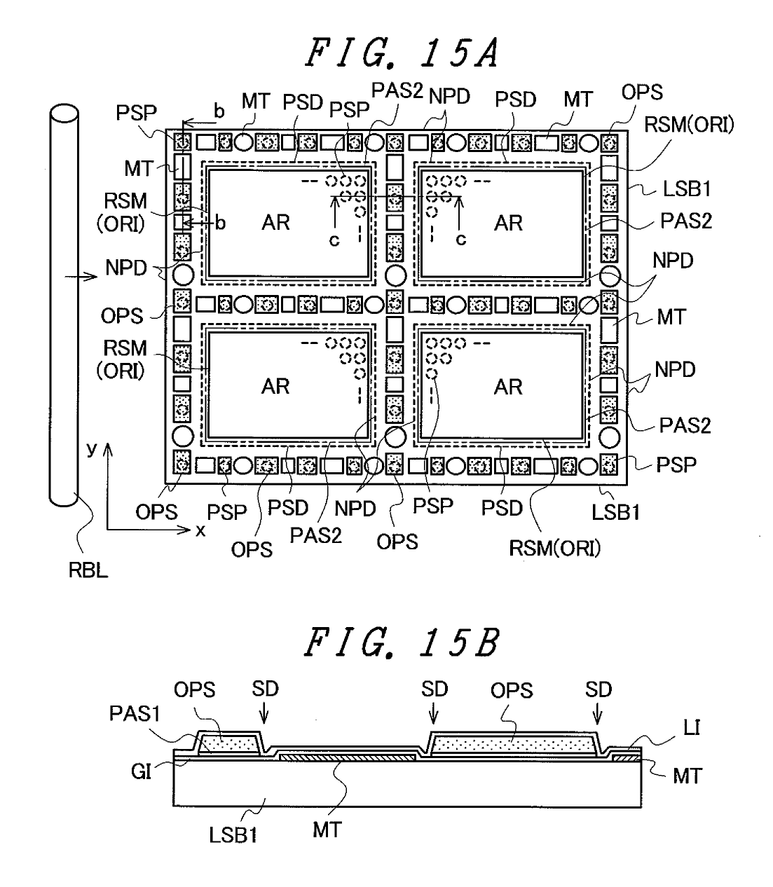

In the case of FIGS. 12A and 12B, the organic insulating film OPS is formed in the pattern in which the plurality of holes HL and notches CL are formed in a staggered form. However, this is not restrictive. For example, as shown in FIG. 13 that is illustrated corresponding to FIG. 12B, a notch CL having a relatively complicated pattern is formed in each of the organic insulating films OPS. As a result, a plurality of organic insulating films OPS(S) each having a small area may be arranged in a staggered form. Also in this case, the organic insulating film OPS is provided with the portion where an organic insulating film is formed and the portion where the organic insulating film is not formed, the portions being arranged with a short distance, along the rubbing direction. The arrangement of the organic insulating film can decrease the fiber irregularities of the rubbing roller RBL.

Although not shown, the organic insulating film OPS may be formed only with the hole HL instead of the notch CL so as to provide the same effect.

Also in the case of Embodiment 4, it is sufficient that the organic insulating film OPS having the above-described pattern, among the organic insulating films OPS formed at the periphery of the panel substrate region PSD, is the organic insulating film OPS formed in the non-panel region on the side positioned on the rubbing start side, among the sides of each of the panel substrate regions PSD, as shown in FIG. 11. However, this is not restrictive. Another organic insulating film OPS formed at the periphery of the panel substrate region PSD may be formed in the above-described pattern.

Embodiment 4 shows the case where the rubbing roller RBL is relatively moved in the x direction in the drawing with the axis of rotation coincident with the y direction in the drawing. However, this is not restrictive. Embodiment 4 may be applied to the case where the rubbing roller RBL is relatively moved in the y direction in the drawing with the axis of rotation coincident with the x direction in the drawing. In this case, a hole or notch is formed in each of the organic insulating films OPS formed in the non-panel region on a side positioned on the rubbing start side (lower side in this case), so that due to the hole or notch, the organic insulating film UPS may be provided with the portion where an organic insulating film is formed and the portion where the organic insulating film is not formed along the rubbing direction.

The invention has been described by using the embodiments. However, the configurations described in the embodiments are illustrative only. The invention can be modified properly in a range not departing from the technical ideal thereof. In addition, the configurations described in the embodiments may be used in combination unless they conflict with each other.

What is claimed is:

1. A method for manufacturing a liquid crystal display device including a first multi-piece substrate and a second multi-piece substrate facing the first multi-piece substrate and having a plurality of column spacers formed thereon, the method comprising the steps of:
in the first multi-piece substrate, forming a stacked body including a first organic insulating film and a resin film disposed on an upper surface of the stacked body and disposed in a forming region of the first organic insulating film as viewed in a plane in a plurality of rectangular panel substrate regions arranged in the first multi-piece substrate, and forming a plurality of patterned metal films and a plurality of rectangular second organic insulating films disposed so as to avoid forming regions of the metal films and serving as bases of the column spacers in a mixed manner along sides of the panel substrate region in a non-panel region at the periphery of each of the panel substrate regions; and
forming an alignment film by rubbing the resin film formed on the upper surface of the stacked body in each of the panel substrate regions of the first multi-piece substrate in a direction substantially parallel to or in a direction substantially perpendicular to an arrangement direction of the panel substrate regions, wherein
in the case where, as viewed in a plane, a side positioned on a start side of the rubbing, among sides of each of the first organic insulating films, is defined as a first side, and each of sides substantially parallel to the rubbing direction, among sides of the second organic insulating film disposed adjacent to the first side, is defined as a second side, a portion of the first side that crosses the second side when the second side is virtually extended in the rubbing direction is formed so as to have a predetermined angle other than 0° and 90° with respect to a direction perpendicular to the rubbing direction.

2. The method for manufacturing the liquid crystal display device according to claim 1, wherein
the first side of the first organic insulating film has a zigzag shape in which peaks and valleys are repeated along a direction crossing the rubbing direction, as viewed in a plane.

3. The method for manufacturing the liquid crystal display device according to claim 1, wherein
the metal film is formed as a mark.

4. The method for manufacturing the liquid crystal display device according to claim 3, wherein
the mark is formed as an alignment mark.

5. The method for manufacturing the liquid crystal display device according to claim 1, wherein
the metal film is formed as a code.

6. A method for manufacturing a liquid crystal display device including a first multi-piece substrate and a second multi-piece substrate facing the first multi-piece substrate and having a plurality of column spacers formed thereon, the method comprising the steps of:
in the first multi-piece substrate, forming a stacked body including a first organic insulating film in a plurality of rectangular panel substrate regions arranged in the first multi-piece substrate, and forming a plurality of patterned metal films and a plurality of second organic insulating films disposed so as to avoid forming regions of the metal films and serving as bases of the column spacers in a mixed manner along sides of the panel substrate region in a non-panel region at the periphery of each of the panel substrate regions; and
forming an alignment film by rubbing a resin film formed on an upper surface of the stacked body in each of the panel substrate regions of the first multi-piece substrate in a direction substantially parallel to or in a direction substantially perpendicular to an arrangement direction of the panel substrate regions, wherein
as viewed in a plane, each of sides crossing a parallel-arranged direction of the second organic insulating films in the second organic insulating film formed in the non-panel region on one side positioned on a start side of the rubbing, among sides of each of the panel substrate regions, has a predetermined angle other than 0° with respect to the rubbing direction.

7. The method for manufacturing the liquid crystal display device according to claim 6, wherein
the second organic insulating film formed in the non-panel region on said one side of the panel substrate region is formed in a trapezoidal pattern with the start side of the rubbing being as an upper side and a side facing the upper side being as a base side, as viewed in a plane.

8. The method for manufacturing the liquid crystal display device according to claim 6, wherein
the metal film is formed as a mark.

9. The method for manufacturing the liquid crystal display device according to claim 8, wherein
the mark is formed as an alignment mark.

10. The method for manufacturing the liquid crystal display device according to claim 6, wherein
the metal film is formed as a code.

11. A method for manufacturing a liquid crystal display device including a first multi-piece substrate and a second multi-piece substrate facing the first multi-piece substrate and having a plurality of column spacers formed thereon, the method comprising the steps of:
in the first multi-piece substrate, forming a stacked body including a first organic insulating film in a plurality of rectangular panel substrate regions arranged in the first multi-piece substrate, and forming a plurality of patterned metal films and a plurality of second organic insulating films disposed so as to avoid forming regions of the metal films and serving as bases of the column spacers in a mixed manner along sides of the panel substrate region in a non-panel region at the periphery of each of the panel substrate regions; and
forming an alignment film by rubbing a resin film formed on an upper surface of the stacked body in each of the panel substrate regions of the first multi-piece substrate in a direction substantially parallel to or in a direction substantially perpendicular to an arrangement direction of the panel substrate regions, wherein
a hole or a notch is formed in each of the second organic insulating films formed in the non-panel region on one side positioned on a start side of the rubbing, among sides of each of the panel substrate regions, as viewed in a plane, and
the second organic insulating film includes a portion where an organic insulating film is formed and a portion where the organic insulating film is not formed along the rubbing direction due to the hole or the notch.

12. The method for manufacturing the liquid crystal display device according to claim 11, wherein
the second organic insulating films formed in the non-panel region on said one side of each of the panel substrate regions are each configured by forming the hole and the notch in plural numbers in a staggered form, as viewed in a plane.

13. The method for manufacturing the liquid crystal display device according to claim 11, wherein
the second organic insulating films formed in the non-panel region on said one side of each of the panel substrate regions are each configured by disposing a plurality of organic insulating films in a staggered form, as viewed in a plane.

14. The method for manufacturing the liquid crystal display device according to claim 11, wherein
the metal film is formed as a mark.

15. The method for manufacturing the liquid crystal display device according to claim 14, wherein
the mark is formed as an alignment mark.

16. The method for manufacturing the liquid crystal display device according to claim 11, wherein
the metal film is formed as a code.

17. The method for manufacturing the liquid crystal display device according to claim 11, wherein
boundaries of fiber irregularities of a rubbing roller for performing the rubbing are made indistinct due to the hole or the notch.

18. A liquid crystal display device produced by
rubbing a resin film formed on an upper surface of a stacked body in each of panel regions of a first substrate in a direction substantially parallel to or in a direction substantially perpendicular to an arrangement direction of the panel regions, and
forming, in the case where a side positioned on a rubbing start side, among sides of each of first organic insulating films, is defined as a first side, and each of sides parallel to a rubbing direction, among sides of a second organic insulating film disposed adjacent to the first side, is defined as a second side, a portion of the first side that crosses the second side when the second side is virtually extended in the rubbing direction so as to have a predetermined angle other than 0° and 90° with respect to a direction perpendicular to the rubbing direction, as viewed in a plane.
